(19) United States
(12) Patent Application Publication
(10) Pub. No.: US 2007/0274607 A1
(43) Pub. Date: Nov. 29, 2007

(54) Method of Creating a Reflection Effect in an Image

(76) Inventors: Jincheng Huang, Lexington, KY (US); Du-Yong Ng, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/279,445

(22) Filed: Apr. 12, 2006

(51) Int. Cl. G06K 9/36

(52) U.S. Cl. 382/276

(57) ABSTRACT

A method of creating a reflection effect in an image includes choosing an observer viewpoint; interpolating selected pixels in the image to generate reflection pixels based on the observer viewpoint; and generating a reconstructed image using the selected pixels and the reflection pixels to create the reflection effect.

### BACKGROUND OF THE INVENTION

1. Field of the Invention

The present invention relates to imaging, and, more particularly, to a method of creating a reflection effect in an image.

2. Description of the Related Art

With the advent of inexpensive digital cameras and image scanning equipment, consumers are able to perform imaging jobs for various purposes more readily than in the past. For example, home users are able to use such equipment to obtain digital images to be used for everyday purposes, such as school projects for both children and adults, the creation of greeting cards, family photo albums, etc. In addition, both small and large business users are able to employ such equipment to obtain images for use in advertising brochures, internal and external presentations, etc.

Various software products allow the manipulation of such digital images in order to achieve the desired end result, an image which may be printed using readily available imaging apparatus, such as inkjet printers, electrophotographic printers, and all-in-one units that are capable of performing multiple types of imaging jobs, such as printing, copying, scanning, and faxing. Such software products may be stand alone products created by various software manufacturers, or may be part of a software bundle packaged with the imaging apparatus.

Although such software products may allow the manipulation and modification of images, the creation of special effects allowed by such software packages is somewhat limited.

What is needed in the art is a method of creating a special effect in an image.

### SUMMARY OF THE INVENTION

The present invention provides a method of creating a reflection effect in an image.

The invention, in one exemplary embodiment, relates to a method of creating a reflection effect in an image. The method includes choosing an observer viewpoint: interpolating selected pixels in the image to generate reflection pixels based on the observer viewpoint; and generating a reconstructed image using the selected pixels and the reflection pixels.

The present invention, in another exemplary embodiment, relates to a method of reconstructing a two-dimensional image to include a reflection effect, the image having a first axis and a second axis. The method includes incorporating the image in a three-dimensional space defined by the first axis, the second axis, and a third axis; defining a surface in the three-dimensional space, the surface having non-zero dimensions along the third axis and at least one of the first axis and the second axis; choosing an observer viewpoint in the three-dimensional space; selecting a retained portion of the image for use in a reconstructed image; interpolating the pixels in the retained portion to generate reflection pixels based on the surface and the observer viewpoint; and generating the reconstructed image using the retained portion of the image and the reflection pixels.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system in accordance with an embodiment of the present invention.

FIG. 2 is a flowchart depicting a method of creating a reflection effect in an image in accordance with an embodiment of the present invention.

FIG. 3 is a depiction of an original image used in describing embodiments of the present invention.

FIG. 4 is a graphic illustration of a geometric setting used in describing embodiments of the present invention.

FIG. 5 is a depiction of a reconstructed image generated in accordance with embodiments of the present invention, having planar ripples.

FIG. 6 is a depiction of a reconstructed image generated in accordance with embodiments of the present invention, having elliptical ripples.

FIG. 7 is a flowchart depicting a method of reconstructing a two-dimensional image to include a reflection effect in accordance with an embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

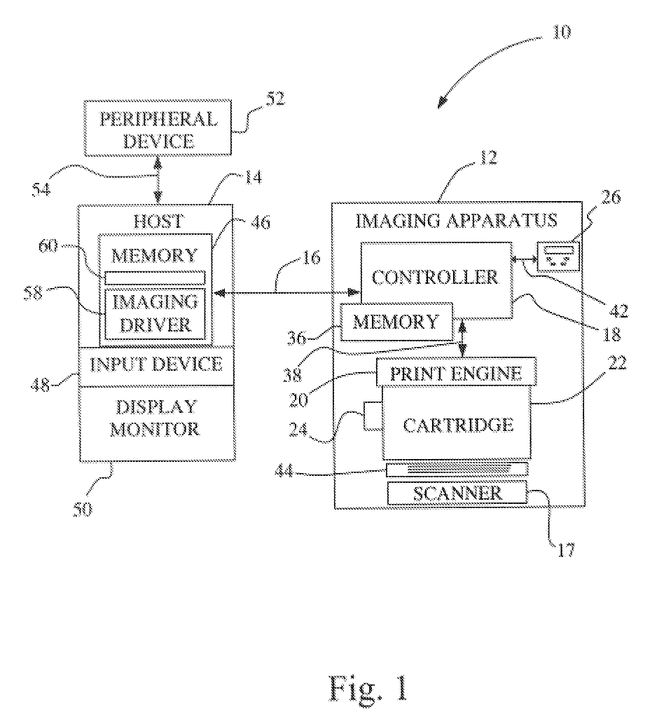

Referring now to the drawings, and particularly to FIG. 1, there is shown a diagrammatic depiction of an imaging system 10 in accordance with an embodiment of the present invention. Imaging system 10 includes an imaging apparatus 12 and a host 14. Imaging apparatus 12 communicates with host 14 via a communications link 16.

Imaging apparatus 12 is an imaging device that produces a printed or scanned output of a patent or latent image. As used herein, an image is a rendering such as may be obtained via a digital camera or scanner, or which may be created or manipulated on a computer, such as host 14, and which may be printed or displayed for viewing by the human eye. Imaging apparatus 12, may be, for example, an ink jet printer and/or copier, electrophotographic (EP) printer and/or copier, or an all-in-one (AIO) unit that includes a printer, a scanner 17, and possibly a fax unit. Imaging apparatus 12 includes a controller 18, a print engine 20, a replaceable cartridge 22 having cartridge memory 24, and a user interface 26.

Controller 18 is communicatively coupled to print engine 20, and print engine 20 is configured to mount cartridge 22. Controller 18 includes a processor unit and associated memory 36, and may be formed as one or more Application Specific Integrated Circuits (ASIC). Controller 18 may be a printer controller, a scanner controller, or may be a combined printer and scanner controller, for example, such as for use in a copier. Although controller 18 is depicted as residing in imaging apparatus 12, alternatively, it is contemplated that all or a portion of controller 18 may reside in host 14. Nonetheless, as used herein, controller 18 is considered to be a part of imaging apparatus 12. Controller 18 communicates with print engine 20 and cartridge 22 via a communications link 38, and with user interface 26 via a communications link 42. Controller 18 serves to process print data and to operate print engine 20 during printing.

In the context of the examples for imaging apparatus 12 given above, print engine 20 may be, for example, an ink jet print engine or an electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 to eject ink droplets onto substrate 44 in order to reproduce text or images, etc. As an electrophotographic print engine, print engine 20 causes cartridge 22 to deposit toner onto substrate 44, which is then fused to substrate 44 by a fuser (not shown). In the embodiment depicted, imaging apparatus 12 is an ink jet unit.

Host 14 may be, for example, a personal computer, including memory 46, an input device 48, such as a keyboard, and a display monitor 50. One or more of a peripheral device 52, such as a digital camera, may be communicatively coupled to host 14 via communication links, such as communication link 54. Alternatively, it is contemplated that peripheral device 52 may be communicatively coupled imaging apparatus 12. Host 14 further includes a processor system, including, for example, at least one microprocessor, and input/output (I/O) interfaces. Host 14 may also include a separate “video card” for performing image (graphics) processing, as is known in the art, which may operate in conjunction with the processor system of host 14. Memory 46 may be any or all of RAM, ROM, NVRAM, or any available type of computer memory, and may include one or more of a mass data storage device, such as a floppy drive, a hard drive, a CD drive, a DVD drive, and/or one or more removable memory cards.

During operation, host 14 includes in its memory 46 program instructions that function as an imaging driver 58, e.g., printer/scanner driver software, for imaging apparatus 12. Imaging driver 58 is in communication with controller 18 of imaging apparatus 12 via communication link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12.

During operation, host 14 also includes in its memory 46 a software program 60 including program instructions for creating a special effect in an image, which in the present embodiments pertains to creating a reflection effect. Although depicted as residing in memory 46 as a stand alone software program, it is contemplated that, alternatively, all or a portion of software program 60 may be formed as part of imaging driver 58. As another alternative, it is contemplated that all or a portion of software program 60 may reside or operate in memory 36 of controller 18. In other alternatives, it is contemplated that software program 60 may reside in whole or in part in any or all of memory 46, memory 36, and peripheral device 52.

The present description of embodiments of the present invention applies equally to operations of software program 60 executing in controller 18 or as part of imaging driver 58, or as a software program separate from imaging driver 58 and controller 18. The instructions executed by the operation of software program 60 are generally described below, and any reference herein to such instructions applies equally to instructions being executed by controller 18, the processor and/or instructions executed as part of imaging driver 58, and/or a processor associated with peripheral device 52. As used herein, imaging driver 58 and software program 60 are considered to be a part of imaging apparatus 12. However, it is alternatively considered that software program 60 may be part of peripheral device 52, e.g. furnished with or loaded into peripheral device 52.

In accordance with the present invention, an image, such as may be obtained via peripheral device 52, scanned by scanner 17, and/or otherwise obtained or created using host 14, is modified, or reconstructed, using software program 60 to create a special effect.

A water reflection effect is an interesting effect to simulate for certain classes of images. Described below is an embodiment of the present invention method that uses a 3D water ripple model and ray tracing to create the effect of water reflection on an image. Given a point to reflect, the pixels above this point are the same as those in the original image. The pixels below this point are water ripples that reflect the pixels above the point. However, the embodiments described herein may be used to create various other special effects, and should not be interpreted as being limited to a water reflection effect.

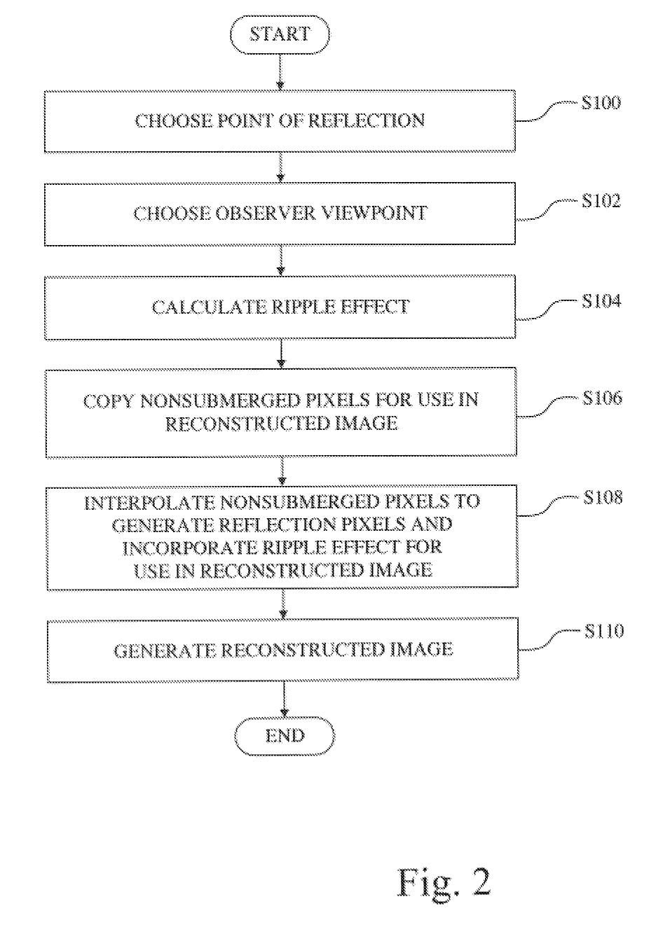

Referring now to FIG. 2, an embodiment of the present invention is described with respect to a flowchart having steps S100-S110, which depicts a method that may be employed in creating a special effect. In particular, the present embodiment is a method of creating a reflection effect in an image. It shall be understood that the present embodiment and invention is not limited to the particular sequence described herein, but rather, that such sequence is employed as a convenience in describing the present embodiment, and that the ordering of each step in the sequence may be altered without departing from the scope of the present embodiment and invention.

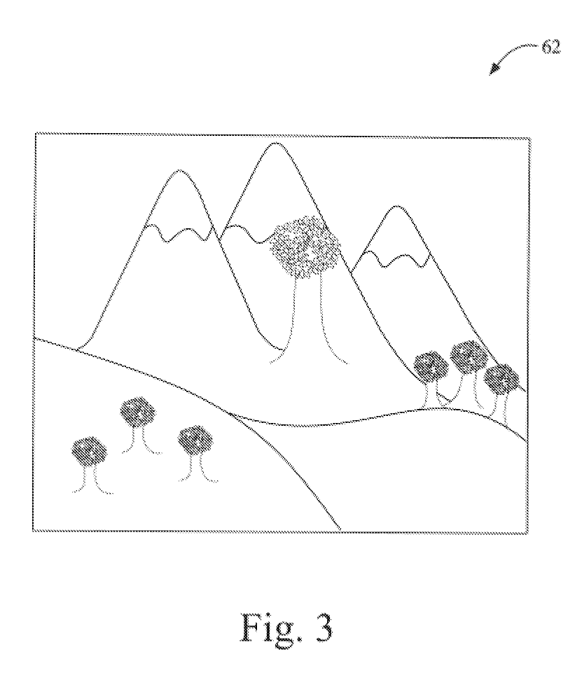

Referring now to FIG. 3, an original image, image 62, is depicted. Implicit in the below description is that an image 62 for which special effects are sought has been captured, and resides in latent form in memory 46 of host 14. Alternatively, it is considered that image 62 resides in memory 36 of imaging apparatus 12, or a memory associated with peripheral device 52 (not shown). In any case, embodiments of the present invention operate upon image 62 in its latent form in creating the special effects described herein.

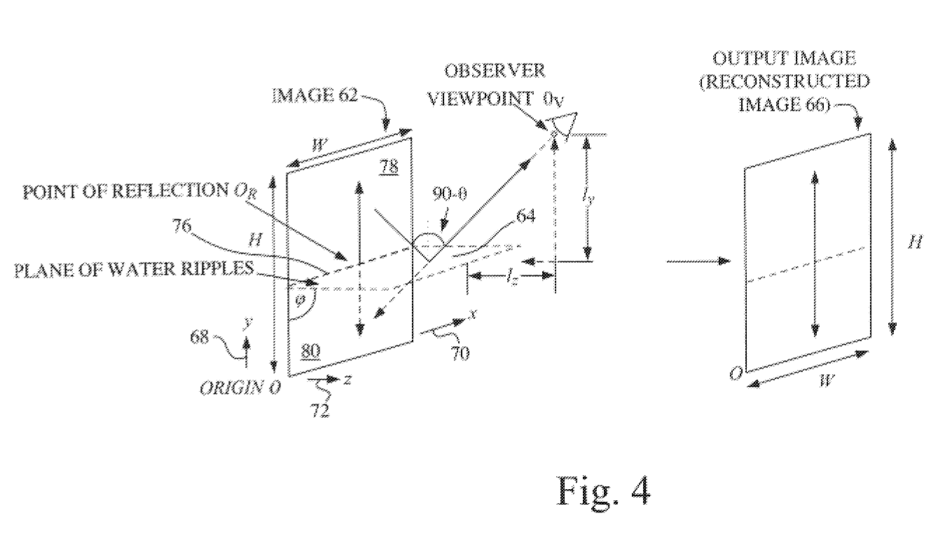

The flowchart of FIG. 2 is described with reference to FIG. 4, which illustrates a geometric setting used to explain the process used to render the effect of water reflection.

Referring now to FIGS. 2 and 4, at step S100, a point of reflection O_{R} is chosen, for example, by a user of host 14, imaging apparatus 12, and/or peripheral device 52. Point of reflection O_{R} is a point on image 62, the pixels above which will be reflected as off a reflection surface 64, as if image 62 in patent form were partially submerged in water up to point of reflection O_{R}, and hence, such pixels are referred to herein as nonsubmerged pixels. Pixels below point of reflection O_{R} are submerged pixels. As set forth in the present embodiment, reflection pixels are interpolated from the nonsubmerged pixels, which represent the pixels seen as being reflected off reflection surface 64.

Alternatively, it is contemplated that point of reflection O_{R} may chosen automatically by software program 60, for example, as a default reflection point.

Point of reflection O_{R}=(Oₓ, O_{y}, O_{z}). The orientation of the surface in which the ripples propagate, reflection surface 64, is assumed to be perpendicular to the image and is assumed to be planar in the present embodiment. In other words, φ in FIG. 4, which represents the angle of reflection surface 64 relative to image 62, is set to 90° in the present embodiment. However, it will be understood that φ need not be 90°, but may be any desired angle, and that reflection surface 64 may be any desired shape, without departing from the scope of the present invention.

At step S102, an observer viewpoint O_{V} is chosen, for example, by the user, which represents the position of an observer that is viewing image 62 in patent form, as if image 62 was partially submerged as set forth above in step S100, and viewed by an observer. In other embodiments, choosing the observer viewpoint may alternatively be choosing an observer viewing angle.

It is contemplated that observer viewpoint O_{V} may alternatively be chosen automatically by software program 60, for example, as a default observer viewpoint.

Observer viewpoint O_{V}=(x, O_{y}+l_{y}, O_{y}+l_{z}) for the observer. In order to preserve the size of the image and avoid mapping pixels outside the boundary of the original image, observer viewpoint O_{V} may be selected so that:

$$tan ( θ ) = \frac{H - {O}_{y}}{{O}_{y}} = \frac{{I}_{y}}{{I}_{z}}$$

in the absence of ripples, wherein line y=O_{y} is the axis of reflection.

At step S104, a ripple effect is calculated for the reflection pixels, as follows.

N sources of ripples are selected, for example by the user, or by software program 60 automatically. It is assumed that the ripples propagate in the direction of radius rᵢ, given as follows:

$${y}_{i} = \{ \begin{matrix}{σ}_{1 , x} \cdot {σ}_{i , x} \cdot \sqrt{\begin{matrix}{( \frac{x - {μ}_{i , s}}{{σ}_{i , x}} )}^{2} - 2 {ρ}_{i , m} ( \frac{x - {μ}_{i , k}}{{σ}_{i , x}} ) \\ ( \frac{z - {μ}_{i , x}}{{σ}_{i , z}} ) + {( \frac{z - {μ}_{i , z}}{{σ}_{i , z}} )}^{2} , \\\end{matrix}} \\ \begin{matrix}\vert z - {μ}_{i , z} \vert , {σ}_{i , x} \to ∞ , 0 < {σ}_{i , z} < ∞ \\ \vert x - {μ}_{i , x} \vert , 0 < {σ}_{i , z} < ∞ , {σ}_{i , x} \to ∞\end{matrix}\end{matrix}$$

where 0<σ_{i,x}<∞,0<σ_{i,z}<∞, and (μ,O_{y},μ_{i,z}) represent the spatial coordinates of the i^{th} source of the ripples. The parameters σ_{i,z} and σ_{i,x} determine the spread of the ripples along the x and the z-axis, and the factor ρ_{i,}specifies the orientation of the ripples in the x-z plane.

A model for the ripples originated from the N sources may be expressed mathematically as:

$$h = {\sum }_{t = 1}^{S} {A}_{i} \cdot {d}_{1} \cdot cos ( {κ}_{i} \cdot {r}_{i } ) .$$

It will be understood that the ripples need not propagate in the direction of rᵢ, but may propagate in other directions, without departing from the scope of the present invention.

In order to calculate the ripple effect, various parameters are selected, for example, by the user, or alternatively, by software program 60. The selected parameters include ripple type, ripple amplitude, and ripple decay function. In the present embodiment, ripple types that may be selected include a planar ripple, an elliptical ripple, and a circular ripple.

The ripple parameters are described as follows:

1. Shape (σ_{i,x},σ_{i,z},ρ_{i,z})

i. Planar ripples
σ_{i,x}<∞ [symbol] σ_{i,z}<∞
ii. Elliptical ripples

$$\{ ( {σ}_{i , x} , {σ}_{i , z} ) \text{:} 0 < \frac{{σ}_{i , z}}{{σ}_{i , x}} < ∞ , {σ}_{i , x} \neq {σ}_{i , z} \} and \{ {ρ}_{i , m} \text{:} \vert {ρ}_{i , m} \vert \leq 1 , {ρ}_{i , m} \neq 0 \}$$

Note that if

$$\frac{{σ}_{i , x}}{{σ}_{i , x}}$$

is sufficiently large, the elliptical ripples approximate planar ripples. This allows planar ripples of any orientation to be approximated with elliptical ripples.
iii. Circular ripples
σ_{i,x}=σ_{i,z} and ρ_{i,}=0
II. The spatial location of the source(s) of the ripples is given by:

$${\{ ( {μ}_{i , x} , {O}_{y} , {μ}_{i , x} ) \}}_{i , m}^{x} ′$$

III. The amplitude of the ripples are given by:

$${\{ A \}}_{i , m}^{x} ′$$

IV. Wave number for the wave associated with each ripple is given as

$${\{ {κ}_{i} \}}_{i , m}^{x} ′$$

where

$${κ}_{i} = \frac{2 κ}{{λ}_{z}} and {λ}_{i}$$

is the wavelength of the i^{th} ripple source.
V. Decay function of the magnitude of the ripples is given by:

$${\{ {d}_{i} \}}_{i , m}^{x} ′$$

The decay function dᵢ is a function of rᵢ.

At step S106, the nonsubmerged pixels, i.e., all the pixels of image 62 that are located above the line y=O_{y}, are copied from image 62 for use in the output image, i.e., a reconstructed image.

At step S108, selected pixels in image 62 are interpolated to generate the reflection pixels based on the observer viewpoint O_{V} and based on point of reflection O_{R}. In addition, the ripple effect is incorporated for use in a reconstructed image. In the present embodiment, the selected pixels are the aforementioned nonsubmerged pixels. As set forth below, and as seen in FIG. 4, the interpolation is performed in the present embodiment using ray tracing.

Step S108 is described as follows:

For every pixel at spatial location (x,y,0) below the axis of reflection in the output image, compute the output pixel value using the following procedures:

$$VI . tan ( \overline{θ} ) = \frac{{l}_{y}}{l \text{?} + y}$$

$$VII . y \text{?} = O \text{?} + h + ( {O}_{y} - y ) \cdot tan ( \overline{θ} )$$

$$VIII . y \text{?} = \{ \begin{matrix}round ( y \text{?} ) - 1 , & if round ( y \text{?} ) > y \text{?} \\ round ( y \text{?} ) , & otherwise\end{matrix} \\ IX . Δ y = y \text{?} - y \text{?} \\ X . y \text{?} = \{ \begin{matrix}H , & if y \text{?} \geq H \\ y \text{?} , & if y \text{?} \geq \overline{y} , \\ \overline{y} , & otherwise\end{matrix} \\ \text{?} \text{indicates text missing or illegible when filed}$$

where y̅ is the threshold below which the pixels in the original image are not reflected. In this disclosure, y̅ is set to O_{y}.

$$XI . y \text{?} = \{ \begin{matrix}y \text{?} + 1 , & if y \text{?} \leq H - 1 \\ H , & otherwise\end{matrix} \\ XII . m = B \cdot ( \frac{a}{N} \cdot {\sum }_{= 1}^{N} \text{?} d \text{?} \cdot cos ( κ \text{?} \cdot r \text{?} ) + b ) \\ \text{?} \text{indicates text missing or illegible when filed}$$

where a+b=1 and 0≦B≦1. The parameters a and b control the modulation on the pixel value whereas the parameter B control the dimness of the reflection.
XIII. Let pᵢ(x,y) and pₒ(x,y) denote the pixel value of the input and output images at spatial location (x,y,0) respectively. Then
p(x,y)=m·(p(x,y)+Δy·(pᵢₓ(x,y)−pᵢₓ(x,y))

At step S110, a reconstructed image 66 is generated using the selected pixels and the reflection pixels, i.e., using the nonsubmerged pixels and the reflection pixels, based the results of step S108.

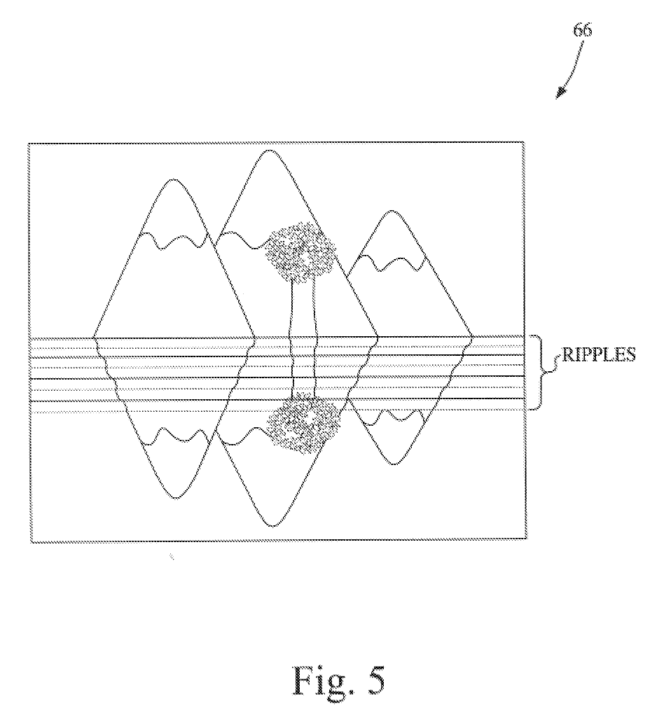

Referring now to FIG. 5, reconstructed image 66 is depicted, which includes a reflection effect having planar ripples as created in accordance with an embodiment of the present invention.

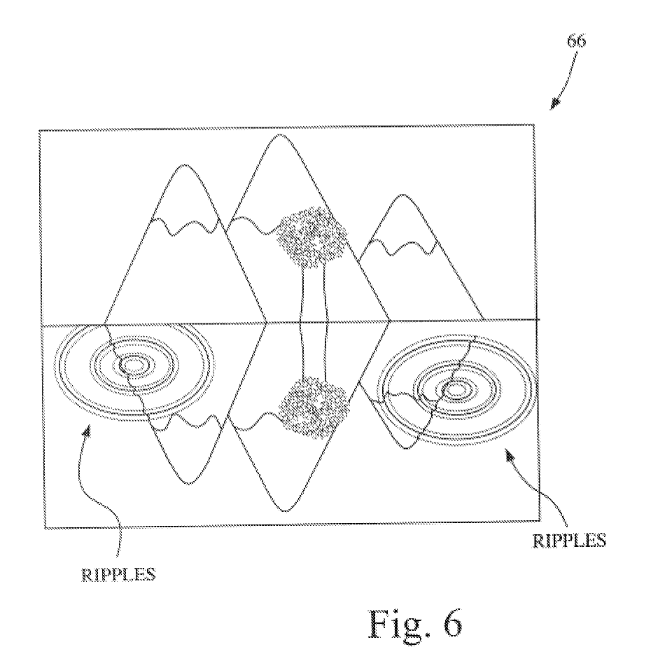

Referring now to FIG. 6, reconstructed image 66 is depicted in another form, which includes a reflection effect having elliptical ripples as created in accordance with an embodiment of the present invention.

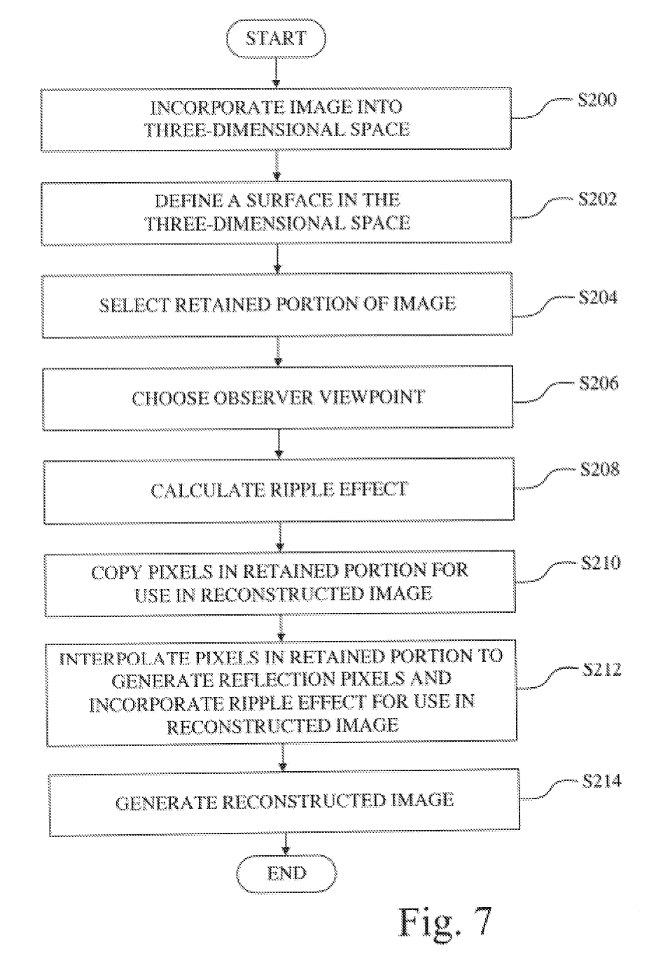

Referring now to FIG. 7, in conjunction with FIG. 4, a method of reconstructing a two-dimensional image 62 to include a reflection effect in accordance with another embodiment of the present invention is depicted with respect to steps S200-S214. In the present embodiment, the image is considered as having a first axis 68, for example, corresponding to the height (H) of the image, and a second axis 70, for example, corresponding to the width (W) of the image.

At step S200, image 62 is incorporated into a three-dimensional space defined by axis 68, axis 70, and having a third axis 72 that lies outside the plane established by axis 68 and axis 70.

At step S202, a surface 64 is defined in the three-dimensional space, surface 64 having non-zero dimensions along axis 72, and along at least one of axis 68 and axis 70. That is, surface 64 may be a plane or may be a three-dimensional surface, depending, for example, on user preferences. For example, the user may desire a reflection effect such as a reflection from a curved or otherwise distorted mirror. In the present embodiment, surface 64 is defined by the user, for example, by selecting from pre-configured shapes available in software program 60. Surface 64 intersects image 62 or an extension of image 62 in the two-dimensional plane defined by image 62, thereby forming an intersection curve 76 that divides image 62 into at least two sub-images, such as sub-images 78 and sub-image 80.

At step S204, a retained portion of image 62 is selected for use in reconstructed image 66. The retained portion of image 62 a selected sub-image, e.g., sub-image 78 or sub-image 80.

Step S204 includes choosing a point of reflection O_{R}, for example, in a manner similar to that described above at step S100 of the previous embodiment. However, in the present embodiment, point of reflection O_{R} may lie on a curve on image 62 that is not a straight line, whereas in the previous embodiment, point of reflection O_{R} is a horizontal line (a line extending in the direction of axis 70). For example, in the present embodiment, point of reflection O_{R} represents a chosen point along intersection curve 76. Since surface 64 may or may not be defined in at step S202 as being planar, depending, for example, on the preferences of the user, it follows that intersection curve 76 may or may not be a straight line.

At step S206, an observer viewpoint O_{V} is chosen. The description of step S102 applies equally to step S206.

At step S208, a ripple effect is calculated for the reflection pixels. The description of step S104 applies equally to step S208.

At step S210, the pixels in the retained portion of image 62 are copied from image 62 for use in the output image, i.e., reconstructed image 66.

At step S212, the pixels in the retained portion of image 62 are interpolated to generate reflection pixels based on surface 64 and said observer viewpoint O_{V}. The description of step S108 applies equally to step S208. As in the previous embodiment, the ripple effect in is incorporated for use in reconstructed image 66. Similarly, the interpolation is performed in the present embodiment using ray tracing.

At step S214, reconstructed image 66 is generated using the retained portion of image 62 and the reflection pixels.

Referring now to FIG. 5, reconstructed image 66 is depicted, which includes a reflection effect having planar ripples as created in accordance with an embodiment of the present invention.

Referring now to FIG. 6, reconstructed image 66 is depicted in another form, which includes a reflection effect having elliptical ripples as created in accordance with an embodiment of the present invention.

While this invention has been described with respect to exemplary embodiments, it will be recognized that the present invention may be further modified within the spirit and scope of this disclosure. This application is therefore intended to cover any variations, uses, or adaptations of the invention using its general principles. Further, this application is intended to cover such departures from the present disclosures as come within known or customary practice in the art to which this invention pertains and which fall within the limits of the appended claims.

What is claimed is:

1. A method of creating a reflection effect in an image; comprising
choosing an observer viewpoint;
interpolating selected pixels in said image to generate reflection pixels based on said observer viewpoint; and
generating a reconstructed image using said selected pixels and said reflection pixels.

2. The method of claim 1, further comprising choosing a point of reflection on said image, the pixels of said image that are above said point of reflection being nonsubmerged pixels, and wherein said interpolating said selected pixels is also based on said point of reflection.

3. The method of claim 2, wherein said interpolating said selected pixels is interpolating said nonsubmerged pixels to generate said reflection pixels, and wherein said generating said reconstructed image is generating said reconstructed image using said nonsubmerged pixels and said reflection pixels.

4. The method of claim 1, wherein said interpolating said selected pixels is performed using ray tracing.

5. The method of claim 1, wherein said choosing said observer viewpoint is choosing an observer viewing angle.

6. The method of claim 1, further comprising:
calculating a ripple effect for said reflection pixels; and
incorporating said ripple effect in said reconstructed image.

7. The method of claim 6, further comprising selecting a ripple type, wherein said ripple type is one of a planar ripple, an elliptical ripple, and a circular ripple.

8. The method of claim 6, further comprising selecting at least one ripple source.

9. The method of claim 6, further comprising selecting at least one of a ripple amplitude and a ripple decay function.

10. A method of reconstructing a two-dimensional image to include a reflection effect, said image having a first axis and a second axis, comprising:
incorporating said image in a three-dimensional space defined by said first axis, said second axis, and a third axis;
defining a surface in said three-dimensional space, said surface having non-zero dimensions along said third axis and at least one of said first axis and said second axis;
choosing an observer viewpoint in said three-dimensional space;
selecting a retained portion of said image for use in a reconstructed image;
interpolating the pixels in said retained portion to generate reflection pixels based on said surface and said observer viewpoint; and
generating said reconstructed image using said retained portion of said image and said reflection pixels.

11. The method of claim 10, wherein:
said surface intersects one of said image and an extension of said image in a two-dimensional plane defined by said image, thereby forming an intersection curve, said intersection curve dividing said image into at least two sub-images; and
said retained portion of said image a selected sub-image of said at least two-sub-images.

12. The method of claim 10, wherein said interpolating said pixels in said retained portion is performed using ray tracing.

13. The method of claim 10, wherein said choosing said observer viewpoint is choosing an observer viewing angle in said three-dimensional space.

14. The method of claim 10, further comprising:
calculating a ripple effect for said reflection pixels; and
incorporating said ripple effect in said reconstructed image.

15. The method of claim 14, further comprising selecting a ripple type, wherein said ripple type is one of a planar ripple, an elliptical ripple, and a circular ripple.

16. The method of claim 14, further comprising selecting at least one ripple source.

17. The method of claim 14, further comprising selecting at least one of a ripple amplitude and a ripple decay function.
